(19) United States
(12) Patent Application Publication
(10) Pub. No.: US 2025/0202834 A1
(43) Pub. Date: Jun. 19, 2025

(54) METHOD AND APPARATUS FOR AVOIDING PACKET MIS-ORDERING WHEN USING VIRTUAL CHANNEL FIFOS IN A DIRECT INTERCONNECT COMPUTER NETWORK

(71) Applicant: Rockport Networks Inc., Ottawa (CA)

(72) Inventors: Alan James JENNINGS, Kanata (CA); Ian Antoine MES, Kanata (CA)

(21) Appl. No.: 18/845,783

(22) PCT Filed: Mar. 3, 2023
(86) PCT No.: PCT/IB2023/000149

§ 371 Date: Sep. 10, 2024

Related U.S. Application Data
(60) Provisional application No. 63/318,991, filed on Mar. 11, 2022.

(51) Int. Cl. H04L 47/62; H04L 45/745

(52) U.S. Cl. CPC H04L 47/6245; H04L 45/745

(57) ABSTRACT

A method for avoiding packet mis-ordering when routing a flow of packets in a direct interconnect network along a path from a source node to a destination node using virtual channel FIFOs. The method involves assigning a VC FIFO buffer for an input port in the next node along the path from the source node to the destination node via a next-hop VC allocation table (NVT), which encodes VC FIFO buffer availability for all packets identified as part of the flow of packets.

### FIELD OF THE INVENTION

The present invention relates to a method of routing packets in a direct interconnect network, but more importantly to the prevention of packet mis-ordering and the avoidance of the need for packet re-ordering when routing packets in a direct interconnect network.

### BACKGROUND OF THE INVENTION

In a direct interconnect network, as described for instance in U.S. Pat. Nos. 10,303,640 and 10,693,767 to Rockport Networks Inc., the disclosures of which are incorporated in their entirety herein by reference, a source node S may send packets to a destination node D over multiple diverse paths (see FIG. 1). Each packet is divided into flits (head, body and tail flits), routed using well-known wormhole switching techniques, and all flits of a packet follow the same path through the network. U.S. Pat. No. 10,693,767, for instance, discloses a computer-implemented method of routing packets in a direct interconnect network from a source node to a destination node comprising the steps of: discovering all nodes and all output ports on each node in the direct interconnect network topology; including the discovered nodes and output ports in the direct interconnect network topology in a topology database that is stored in all nodes in order to allow the nodes and ports to be included in path routing computations; calculating a path from every output port on each node to every other node in the direct interconnect network topology based on those nodes and output ports contained in the topology database, wherein each such path is disjoint from one another, and wherein calculating the disjoint paths is performed independently by each node without the need for any centralized controller within the direct interconnect network topology to assist with same; generating a source routing database on each node containing the disjoint paths from every output port on each node to all other nodes in the direct interconnect network topology; receiving a packet at the source node; sending the received packet to one of the output ports of the source node as chosen in a round robin, weighted round robin, random distribution, or other calculated path selection process, whereby the packet is thereafter segmented into flits and then distributed along the disjoint path from the chosen output port on the source node to the destination node.

FIG. 2 shows an example of a simple direct interconnect network with four nodes (A, B, C, and D). All links are point-to-point and (using an arbitrary port assignment) the nodes have been connected to form a two-dimensional torus. In general, a direct interconnect network might be formed with any arbitrary topology including well-known flattened butterfly or dragonfly networks as well as a torus. The paths to be calculated by the routing algorithm are a function of the topology and port assignments. In this example, using source routing represented as a list of output port numbers, possible paths from node A to node B include, but are not limited to, {0,3,3}, {1}, {2,3,1}, and {3}.

U.S. Patent Application Nos. 63/208,774 and 63/214,061 to Rockport Networks Inc., the disclosures of which are incorporated herein by reference, disclose methods of distributing multipath flows and deadlock-free multipath routing, respectively, in direct interconnect networks.

FIG. 3 shows an example of a fragment of a network in which a source node S has a path to a destination node D via intermediate nodes A and B. Each node, including source node S, contains a set of per-destination node state data including data in the form of a Path Lookup Table (PLT) which contains a list of available paths to each destination node, each path being computed using a technique known to persons skilled in the art, or as described in U.S. Pat. No. 10,693,767 and U.S. Patent Application No. 63/208,774, for example. Each path may be represented as a sequence of exit port numbers with a terminator value indicating the end of the list (thereby denoting the end of the path/destination node). In the example in FIG. 3, node S has a path to node D designated as {3,1,2,F} consisting of the exit ports of nodes S, A, B and D respectively, where F denotes an example method of designating a path terminator indicating that the packets should be sent to the local host instead of an output port to another node.

FIG. 4 illustrates a generic flit switching node, containing components well known to those skilled in the art, including:
A multitude of Virtual Channel (VC) FIFO (first in, first out) buffers per input port (see e.g. VC0-VCn);
A VC Allocation (VA) function to allocate flits from VC FIFOs to the VCs in downstream nodes. This may be a single function per port, or divided into separate selections based on criteria such as priorities or layers;
A Switch Allocation (SA) function to select which flits are sent to each output port from the current set of allocated VCs to each input port. This may be a simple round-robin allocation, for instance, or may include other priorities or weights based on traffic priorities, layers, congestion or other parameters;
A flit switch to connect the VC FIFOs to output ports; and
Sources and sinks of data that are local to the node, having one or more ports to the switch.

On each link between nodes, the VC FIFOs on each input port are typically required to buffer data for flow control purposes. FIG. 5 illustrates the well-known problem of head-of-line blocking when only a single FIFO is used per input port. In this example, let's assume node D sends flit C0 to node C, while node B sends flit C1 to node C followed by flit D1 to node D. Node A would allocate C0 to the port to node C (i.e. Port 1 out), which means C1 must wait until this is completed. The problem, however, is that D1 must also wait behind C1 (as it is buffered in the input FIFO) even though the port to node D (i.e. Port 2 out) is currently idle. This has the potential to greatly affect throughput and efficiency of the direct interconnect network.

To reduce head-of-line blocking at each node, the links may be divided into virtual channels (VCs) with separate FIFO buffering per VC (as shown in FIG. 4). In this respect, in each node the head flit must arbitrate for a VC to exit on its next hop link, such that packets passing over a link are assigned a VC at the head flit and all flits of a packet will use the same receive VC FIFO. However, the head flit may be required to wait while other traffic is using the same link, and the use of multiple VCs per link thereby allows packets to pass other waiting packets—this is generally desired and intended for the case where a subsequent packet is destined for a different output link that may not be blocked. The use of multiple VCs for this purpose can thereby greatly improve the efficiency of a direct interconnect network, such as those implemented in a torus or dragonfly topology, but it can lead to the possibility of packet mis-ordering if packets from a flow to a destination node can be sent via more than one VC. This is partially explained with reference to FIG. 6, which provides an illustrative example of a network comprising similar nodes capable of flit switching, wherein all nodes have 2 VCs on each input link, packets are assigned to VCs by a VC Allocation (VA) function before the head flit of a packet is sent, and a Switch Allocation (SA) function arbitrates between the waiting flits that have been allocated a VC to pick the next one to send. In this illustrative example, an example packet flow with the use of VCs could proceed as follows:
Node D sends a flow of flits through Node A port 2 to Node C.
Node E sends a flow of flits through Node A port 3 also to Node C.
Node A's VA function will allocate a separate VC to both Node D's and Node E's flows (e.g. VC0 for both port 2 and 3 for the Node D and Node E flows respectively), and the SA function will interleave the flits over Node A's Port 1 link (to Node C).
Node B has two flows of flits to send to Nodes C and D respectively via its link to Node A
Node B's flits to Node C are allocated to input VC0, but are currently blocked since all the output VCs to Node C are already in use (e.g. by the Node D packet already allocated to its output VC0 and by the Node E packet already allocated to its output VC0).
Node B's flits to Node D are allocated to VC1, allowing them to flow to Node D which was idle.

In this example, the flow from Node B to Node D is able to continue because of the fact that there are two input VC FIFOs, which allows the Node B-D flow in the VC1 FIFO to bypass the flits in the VC0 FIFO that are waiting to exit port 1 to Node C. With only a single receive FIFO there would have been head-of-line blocking instead, as shown in the example at FIG. 5. Of note, in a practical implementation there may be multiple VC FIFOs per link, perhaps divided into separate priorities or separated into layer groups.

Many types of traffic such as TCP or RoCEv2 flows require that a single flow of packets is received strictly in order, and there are performance penalties if this is not the case. However, even the existence of two or more VC FIFOs for a link has the potential to allow packets from the same flow to pass each other, as noted above, depending on the VA and SA algorithms employed. For example, in the case where the VC is allocated on a packet-by-packet basis while there is room in a VC FIFO, packets from the same flow from a source node(S) to a destination node (D) might be sent over the same link to different VC FIFOs. Then, depending on the order in which they are read, the later one may be sent first, resulting in mis-ordering.

An example of such packet mis-ordering is provided with reference to FIG. 7. When two packets with the same global path (i.e. same source, same destination, same path to destination) are injected into the network, they are injected sequentially into the network (i.e. the second packet does not start until the first packet is fully injected). As the packet progresses through each hop, the packets will continue to traverse the network sequentially if they use the same VC at each hop. However, when there is more than one VC per input link, it is possible for these packets to use different VCs, and once the packets are on different VCs, their order is no longer necessarily maintained. FIG. 7 shows two packets entering the node: packet A consisting of 5 flits sent to VC0; and packet B contained in a single flit sent to VC1. As shown, the packet B flit is interleaved within the packet A flits upon node exit. Such packet mis-ordering requires resources to re-order the packets into proper order upon arrival at the destination node.

Various techniques are possible to prevent mis-ordering, with trade-offs in complexity and blocking efficiency. For example, at the source node, selecting a VC number to be used at all intermediate nodes for all packets to a given destination would prevent mis-ordering, but has significant detrimental consequences for throughput, compared to dynamic methods of VC allocation. However, such dynamic VC allocation techniques usually require significant state information to be stored and updated. In a flit switch with multiple VCs per link, and multiple links, storing per-VC or per-packet flow state can be expensive to implement.

The present invention seeks to overcome at least some of the above-mentioned shortcomings. More particularly, this invention describes an efficient method of preventing packet mis-ordering and minimizing the need for packet re-ordering when using VCs by the use of a minimal size state table.

### SUMMARY OF THE INVENTION

In one aspect, the present invention provides a node designed to prevent packet mis-ordering when routing a flow of packets in a direct interconnect network, said node comprising: at least one input port for receiving the flow of packets; at least one virtual channel (VC) FIFO (first in, first out) buffer per the at least one input port for buffering packet flits in the flow of packets; at least one flit switch with at least one output port for sending packet flits in the flow of packets to another node; at least one switch allocation (SA) function for selecting which packet flits are sent to the at least one output port; and at least one virtual channel allocation (VA) function for assigning packet flits to at least one virtual channel FIFO buffer in the another node, wherein said assigning packet flits comprises utilizing a next-hop virtual channel allocation table (NVT) for encoding virtual channel state to ensure packet flits in the flow of packets are allocated to the same VC FIFO buffer in the another node to prevent packet mis-ordering.

The node may have at least one switch allocation function per output port, and may have at least one virtual channel allocation function per output port. The virtual channel state encoding in the next-hop virtual channel allocation table may denote availability for the flow of packets.

In another aspect, the present invention provides a method for avoiding packet mis-ordering when routing a flow of packets in a direct interconnect network along a path from a source node to a destination node using virtual channel FIFOs, said method comprising: receiving a packet into a virtual channel (VC) FIFO (first in, first out) buffer from an input port on the source node, said packet comprising packet flits and having a head flit; when said head flit is at the front of the VC FIFO buffer, requesting from a virtual channel allocation (VA) function an exit port from which the packet flits will exit the source node, based on path information contained in the head flit, and further including a next hop exit port from which the packet flits will exit a next node in the path from the source node to the destination node; assigning a VC FIFO buffer for an input port in the next node in the path from the source node to the destination node via a next-hop VC allocation table (NVT), wherein said NVT encodes an available VC FIFO buffer to use in the next node for all packets identified as part of the flow of packets; using a switch allocation function to select the packet flits to be sent to the exit port from which the packet flits will exit the source node; sending the packet flits from the VC FIFO buffer to the exit port via a flit switch, and routing the packets to the VC FIFO buffer for the input port in the next node, as assigned by the NVT; and repeating this method for all nodes in the path from the source node to the destination node until the flow of packets arrive at the destination node.

### BRIEF DESCRIPTION OF THE DRAWINGS

The invention will now be described, by way of example, with reference to the accompanying drawings in which:

FIG. 1 is a diagram displaying multiple diverse paths for routing from source node S to destination node D;

FIG. 2 is a diagram showing an example 4-node, two-dimensional torus with arbitrary port numbering;

FIG. 3 is a diagram showing an example of a path between source node S and destination node D via intermediate nodes A and B;

FIG. 4 is a diagram of a prior art generic flit switch, with example components including multiple VC FIFOs per input port, a flit switch, a VC Allocation (VA) function and a Switch Allocation (SA) function;

FIG. 5 is a diagram for explaining head-of-line blocking when using a single input FIFO in a prior art generic flit switch;

FIG. 6 is a diagram showing an example of the use of virtual channels in a prior art generic flit switch with packet flows;

FIG. 7 is a diagram showing how packets may be mis-ordered in a flow where virtual channels are used;

FIG. 8 is a diagram showing a node with a Next-Hop Virtual Channel Allocation Table used to prevent packet mis-ordering;

FIG. 9 is an example of a Next-Hop VC Allocation Table (NVT) for an output port VC Allocation (VA) function.

FIG. 10 expands on the diagram in FIG. 3 and shows an example of a common partial path between different source-destination node pairs via intermediate nodes A and B.

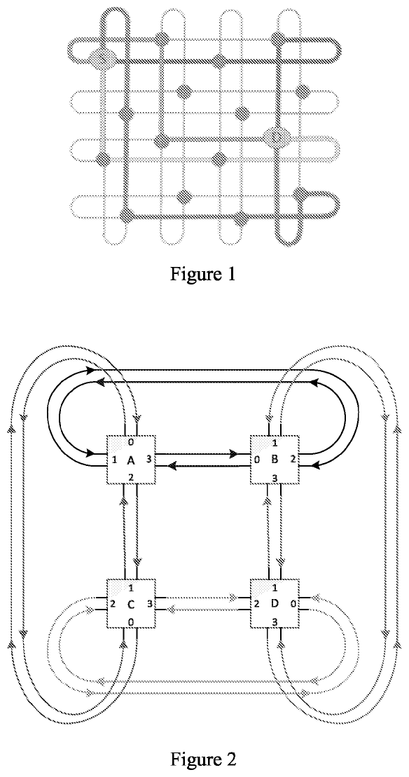

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION OF THE INVENTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

It will be appreciated that any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

In order to prevent packet mis-ordering, what is actually required is to prevent mis-ordering packets within the same flow, while packets for separate flows may pass each other without issue. For the purposes of the present invention, the definition of an individual packet flow may include some or all of the following: (i) same source node(S); (ii) same destination node (D); (iii) same protocol; (iv) same IPv4 or IPv6 addresses; (v) same port numbers (e.g. UDP or TCP ports); and (vi) same Queue Pair (e.g. RoCEv2).

In a network, the number of packet flows may number in the many millions, with new flows appearing and disappearing dynamically. Identifying packet flows requires inspection of the headers and typically a form of hashing to label packets within a compressed flow-id space.

To prevent packet mis-ordering in a set of VCs on a link, various techniques could be used such as: (i) identifying a flow and always assigning its packets to the same VC FIFO, or (ii) identifying a flow, timestamping all packets, and placing them in any VC but preventing a later timestamped packet from the same flow being read before an earlier timestamped packet.

The fundamental problems with any scheme that uses flow identification using hashing include:
the cost of inspecting multiple fields in a packet and calculating a flow-id as a hash of these fields
having to either carry the flow-id with every packet (bandwidth overhead) or having to repeat the calculation at each node
having to use a large flow-id space, resulting in large impractical tables to store and maintain, per link, or
having to use a small flow-id space, resulting in frequent hash collisions (and in this case unnecessary head-of-line blocking).

The solution needed is thus to identify flows, or sets of flows, whose VA and SA selections are restricted to those that prevent packet mis-ordering, while minimizing state space and complexity.

The present invention stems from the fact that when utilizing source routing and wormhole switching in a direct interconnect network, because path selection uses methods such as flow hashing, all packets of a flow will follow the same path into and out of each node, and packets going out the same link are competing within the same SA process for selection. The present invention therefore utilizes the next-hop (next node's output port) as a method to select VC assignments. In this respect, for each group of VCs on a link (i.e. all VCs in the same priority/layer), the present invention involves maintaining a table mapping next-hop values to VC assignments, referred to herein as the Next-hop VC Allocation Table (NVT). The depth of each table required is thereby reduced from the large number for other previously mentioned flow mis-order prevention techniques to a much smaller, practical number to implement based on the number of output ports (radix of the switch), while still removing head-of-line blocking to other ports.

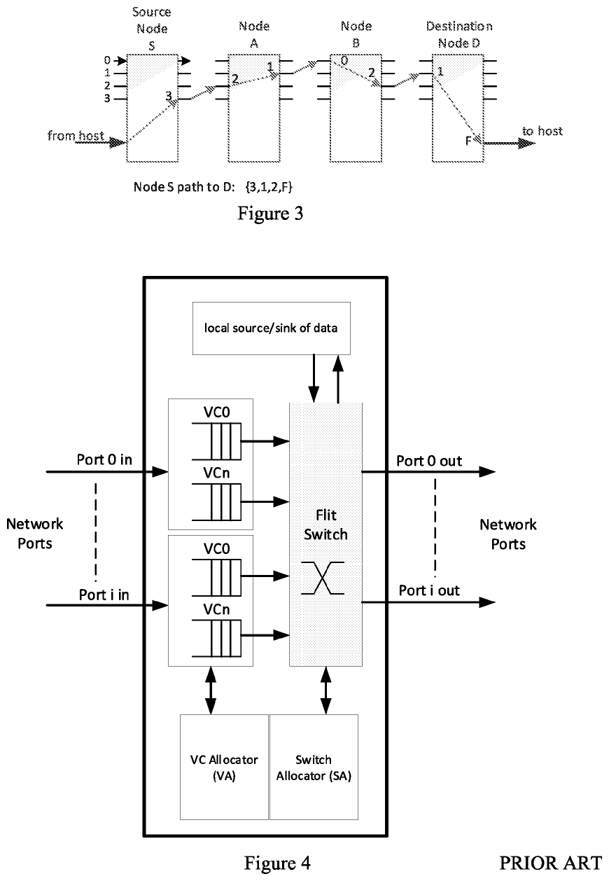

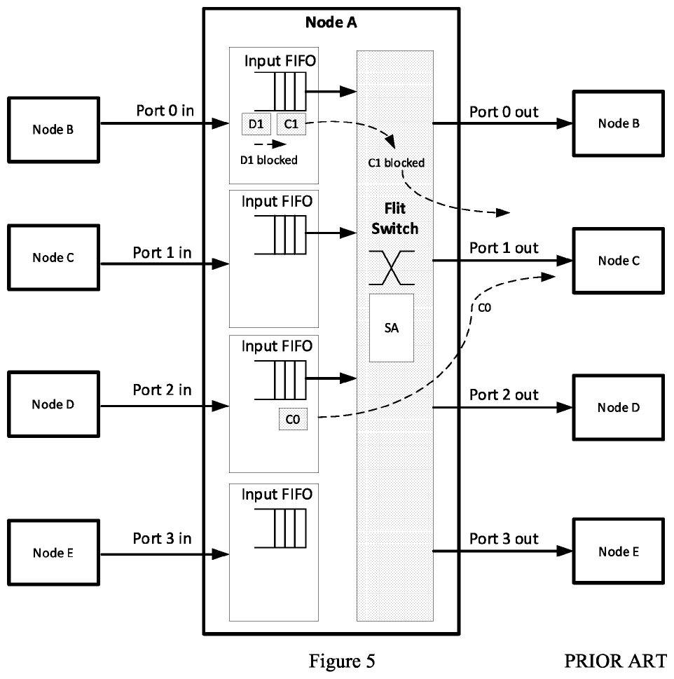

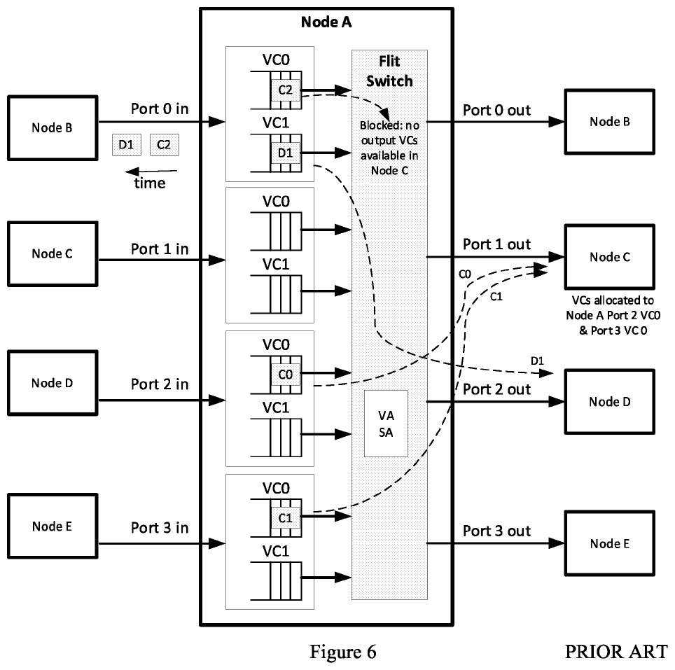

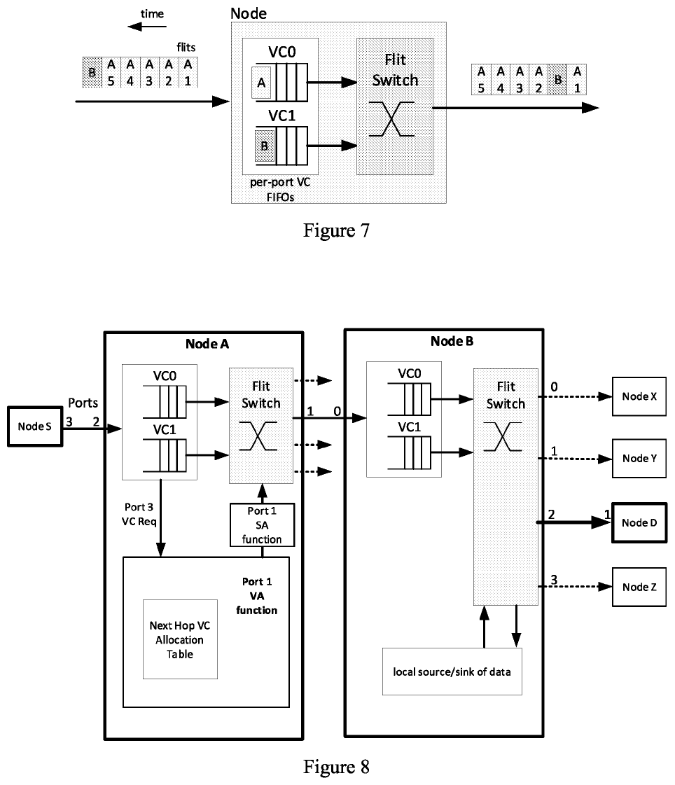

FIG. 8 is used to assist with providing an example of the mechanism. Referring to FIG. 8, Node A contains the following noted structures and/or functionality:
Input ports, e.g. port 2 input from Source node S
A flit switch with multiple output ports, including, for e.g., output port 1 which is connected to Node B
At least one Switch Allocation (SA) function to select the flits sent to each output port, e.g. output port 1 (in a preferred implementation there is one SA per output port, but other implementations are possible)
At least one VC Allocation (VA) function for the output ports, e.g. output port 1, which will assign packets to the VC FIFOs in node B (in a preferred implementation there is one VA per output port, but other implementations are possible)
Within Node A's VA function(s), a Next-hop VC Allocation Table (NVT), the use of which will be described below
When there is a head flit at the head of a VC FIFO in Node A, it indicates a request to the VA function for the port from which the flit is going to exit the node, based on the path information contained in the head flit header.
Additionally for this invention, the request to the VA will include the next hop information i.e. the exit port on Node B downstream. In this respect, with reference to the example in FIG. 3, packets from source node S to destination node D may be assigned a path through nodes A and B designated by the path {3,1,2,F}. Therefore in node A it can identify the exit port from node A as port 1 and the exit port from node B as 2 (i.e. the next-hop value).

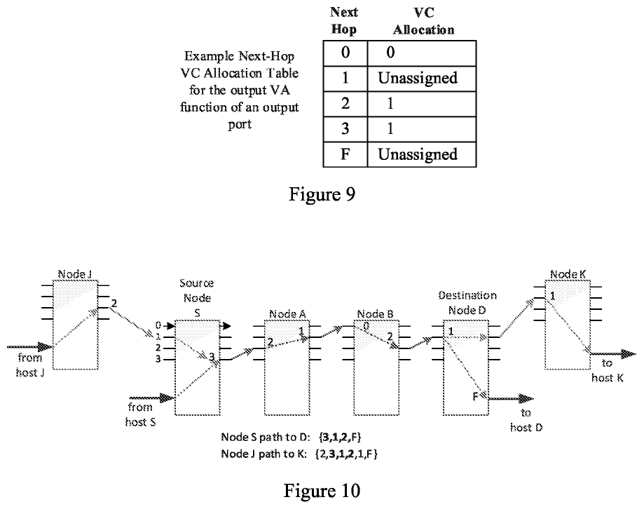

The VA function in Node A for a given output link will:
for each output VC in the downstream node (e.g. see in FIG. 8 the VC FIFOs in Node B for its link from Node A), select which source of data is assigned to it on a packet-by-packet basis. The sources of data in Node A include the set of all input VCs and the local Node A sources that have packets waiting to go to the downstream node. The VC assignment is recalculated for every packet sent. A simple VA function might, for example, select a new input VC by a round-robin method from the set of requesting sources each time an output VC in the downstream node becomes available, although other methods will be known to those skilled in the art.
additionally maintain (per-layer, per port) a Next-hop VC Allocation Table (NVT), of N entries (R ports+local sinks) of Y bits, encoding the full range of available VCs plus an unassigned state. In the example shown in FIG. 8 where Node B has 2 VCs per link, 4 output network ports and one local data sink port, Nodes A's NVT table would require 5 entries of 2-bits. Each entry could be encoded as, for example: {0x0=VC0, 0x1=VC1, 0x2=reserved, 0x3=Unassigned}. All entries in the NVT would initially be in the Unassigned state.
for each new head flit (start of packet) with next-hop value N, look-up in the NVT to see if that next-hop value has an assigned VC. If the VC is assigned, use the same VC again; and if unassigned, load balance assignments over the VCs (pick the least used VC in the NVT). This has the effect of temporarily locking a next-hop to an output VC. For example, FIG. 9 shows a possible configuration for node A's NVT on the link to node B, where the next hop value 2 is assigned to VC 1. Using these values in node A's port 1 VA function, all packets from node S to node D will be assigned in node A to use VC1 in node B port 0, while all packets from node S to node X (next-hop=0) are assigned to use VC0.
Use methods described below to clear the entries in the NVT back to the Unassigned state.

In the FIG. 8 example, since all packets using the path from node S to node D use only VC1 in node B input port 0, there is no possibility of mis-ordering with the flow. Likewise, all packets using the path from node S to node X use only VC0 in node B input port 0.

The methods to clear entries back to Unassigned in the NVT table allow the VCs to be reassigned as the traffic changes dynamically over time. Since there may be less VCs available for a link than the number of next-hops, it is advantageous to load balance the active next-hops over the available VCs for performance reasons. This cannot be done without knowing the traffic patterns, so dynamic assignment is preferred. But over time if the traffic patterns change the load on the VCs may become unbalanced if the same assignment remains active. For example, if an NVT with 4 entries initially assigns next-hops 0 and 1 to use VC 0 and next-hops 2 and 3 to use VC1, and then later all the traffic flows use next-hop 2 and 3 only, then VC1 will be used while VC0 is unused leading to potential blocking of flows. If the load balancing was recalculated, then next-hop 2 could be assigned one VC and next-hop 3 the other, reducing the potential blocking. The issue with adjusting the NVT entries is to not create unwanted mis-ordering in active flows. This can be prevented by the following methods.

The state for a given next-hop entry in the NVT is set to Unassigned if it is detected that there can be no more packets for the same next-hop in the VC FIFO in the downstream node. This is detected in two different ways:
If the VC FIFO in the next node is empty, then the state for all next-hops assigned to the VC are cleared. (Numerous methods of signaling to the upstream node the fill state of a VC FIFO will be well known to those skilled in the art, depending on the flow control mechanisms employed, but could include monitoring a FIFO credit balance or explicit signaling of the condition.)
If the entire VC FIFO in the next node has been overwritten without ever having a VC open (i.e. a new packet assigned) for a given next-hop, then the state for the given next-hop is cleared. In this case we are guaranteed that there are no packets in the assigned FIFO, and so it is safe to reassign the NVT entry to any VC again without causing packet reordering. This technique requires a method to monitor the amount of data sent to the VC relative to the size of its FIFO, and also monitor the assignment of new packets.

When an NVT entry is currently unassigned and a new VC assignment is required, the simplest preferred method is to select the least used VC currently in the table, but other methods of balancing the use of the VCs over the NVT entries are possible if there is more knowledge of the traffic patterns available, such as methods based on dynamic routing or congestion management techniques.

This method does have some restrictions on the VC assignments and blocking compared to an ideal perfect per-flow VC assignment. For example, with reference to FIG. 8, if a source node G was sending packets to another node H using the same path through nodes A and B, it would be restricted to use the same VC assignment as the packets from nodes S to D even though they are unrelated. The techniques described in this invention prevent the issue with packet mis-ordering for both flows, at the expense of some potential blocking between them, but the state-space requirements to prevent reordering are vastly reduced.

Many flows could have different source and destination nodes, but still pass through the same two links in order. FIG. 10 expands upon the example in FIG. 3 and shows a path from node J to node K with path {2,3,1,2,1,F}, such that it has some common links to the path from node S to node D. In this case the flows from J to K and from S to D will be assigned the same VC in node A's NVT since they have the same output port and next-hop value. This restriction is a consequence of the small NVT state stored, but since these flows will be subject to the same congestion over these common links, and will compete for the same SA function in node A, the availability of more VCs would not significantly improve performance.

This simple and efficient technique may be implemented in hardware such as FPGAs and ASICs to prevent mis-ordering while greatly reducing the hardware costs compared to other techniques such as timestamping or flow hashing, as described above.

We claim:

1. A node designed to prevent packet mis-ordering when routing a flow of packets in a direct interconnect network, said node comprising:
at least one input port for receiving the flow of packets;
at least one virtual channel (VC) FIFO (first in, first out) buffer per the at least one input port for buffering packet flits in the flow of packets;
at least one flit switch with at least one output port for sending packet flits in the flow of packets to another node;
at least one switch allocation (SA) function for selecting which packet flits are sent to the at least one output port; and
at least one virtual channel allocation (VA) function for assigning packet flits to at least one virtual channel FIFO buffer in the another node,
wherein said assigning packet flits comprises utilizing a next-hop virtual channel allocation table (NVT) for encoding virtual channel state to ensure packet flits in the flow of packets are allocated to the same VC FIFO buffer in the another node to prevent packet mis-ordering.

2. The node of claim 1, wherein said node has at least one switch allocation function per output port.

3. The node of claim 1, wherein said node has at least one virtual channel allocation function per output port.

4. The node of claim 1, wherein the virtual channel state encoding in the next-hop virtual channel allocation table denotes availability for the flow of packets.

5. A method for avoiding packet mis-ordering when routing a flow of packets in a direct interconnect network along a path from a source node to a destination node using virtual channel FIFOs, said method comprising:
receiving a packet into a virtual channel (VC) FIFO (first in, first out) buffer from an input port on the source node, said packet comprising packet flits and having a head flit,
when said head flit is at the front of the VC FIFO buffer, requesting from a virtual channel allocation (VA) function an exit port from which the packet flits will exit the source node, based on path information contained in the head flit, and further including a next hop exit port from which the packet flits will exit a next node in the path from the source node to the destination node,
assigning a VC FIFO buffer for an input port in the next node in the path from the source node to the destination node via a next-hop VC allocation table (NVT), wherein said NVT encodes an available VC FIFO buffer to use in the next node for all packets identified as part of the flow of packets,
using a switch allocation function to select the packet flits to be sent to the exit port from which the packet flits will exit the source node,
sending the packet flits from the VC FIFO buffer to the exit port via a flit switch, and routing the packets to the VC FIFO buffer for the input port in the next node, as assigned by the NVT,
and repeating this method for all nodes in the path from the source node to the destination node until the flow of packets arrive at the destination node.
